(19) United States
(12) Patent Application Publication
(10) Pub. No.: US 2018/0177284 A1
(43) Pub. Date: Jun. 28, 2018

(54) PHONE CARRIER

(71) Applicant: Black Rapid, Inc., Seattle, WA (US)

(72) Inventor: Lilian Zagorski, Seattle, WA (US)

(21) Appl. No.: 15/833,587

(22) Filed: Dec. 6, 2017

Related U.S. Application Data
(60) Provisional application No. 62/439,349, filed on Dec. 27, 2016.

(51) Int. Cl. A45F 5/00; H04B 1/3888

(52) U.S. Cl. CPC A45F 5/004; A45F 2200/0516; A45F 2005/008; H04B 1/3888

(57) ABSTRACT

A carrier for use with a cellular telephone and a removable case configured to receive the cellular telephone. The carrier includes a tab portion and a loop. The tab portion is configured to be positioned between the cellular telephone and the case when the cellular telephone is received within the case. The loop is connected to the tab portion and extends outwardly therefrom. The loop is configured to extend outwardly from the case through a through-hole formed in the case when the tab portion is positioned between the cellular telephone and the case.

### CROSS REFERENCE TO RELATED APPLICATION(S)

This application claims the benefit of U.S. Provisional Application No. 62/439,349, filed on Dec. 27, 2016, which is incorporated herein by reference in its entirety.

### BACKGROUND OF THE INVENTION

### Field of the Invention

The present invention is directed generally to accessories used with cellular telephones and/or cellular telephone cases.

### Description of the Related Art

Cellular telephones have become a part of everyday life. Unfortunately, these important devices are frequently dropped, stolen, and/or misplaced by users. Therefore, a need exists for methods and devices that help avoid these problems. The present application provides these and other advantages as will be apparent from the following detailed description and accompanying figures.

### BRIEF DESCRIPTION OF THE SEVERAL VIEWS OF THE DRAWING(S)

FIG. 1 is a perspective view of an assembly that includes a cellphone, a cellphone case, and a carrier.

FIG. 2 is a rear view of the assembly of FIG. 1.

FIG. 3 is a front side perspective view of the carrier of FIG. 1.

FIG. 4 is a rear side perspective view of the carrier of FIG. 1.

FIG. 5 is a perspective view of the carrier of FIG. 1 attached to a wrist strap assembly.

FIG. 6 is a first perspective view of the carrier of FIG. 1 attached to a strap attachment.

FIG. 7 is a second perspective view of the carrier of FIG. 1 attached to the strap attachment and positioned by a user such that the user may use the cellphone.

FIG. 8 is a first perspective view of the carrier of FIG. 1 attached to a cross-body sling strap.

FIG. 9 is a second perspective view of the carrier of FIG. 1 attached to the cross-body sling strap and positioned by the user such that the user may use the cellphone.

FIG. 10 is a first perspective view of the carrier of FIG. 1 attached to a retractable reel assembly.

FIG. 11 is a second perspective view of the carrier of FIG. 1 attached to the retractable reel assembly and positioned by the user such that the user may use the cellphone.

FIG. 12 is a perspective view of the carrier of FIG. 1 attached by a clasp to a backpack strap.

FIG. 13 is a perspective view of a kit including the carrier of FIG. 1.

FIG. 14 is a perspective view of the carrier of FIG. 1 positioned inside the case.

FIG. 15 is a perspective view of the cellphone being inserted into the case after the carrier has already been positioned inside the case.

FIG. 16 is a perspective view of a generally T-shaped piece of material that may be used to construct the carrier of FIG. 1.

FIG. 17 is a front view of the carrier of FIG. 1.

Like reference numerals have been used in the figures to identify like components.

### DETAILED DESCRIPTION OF THE INVENTION

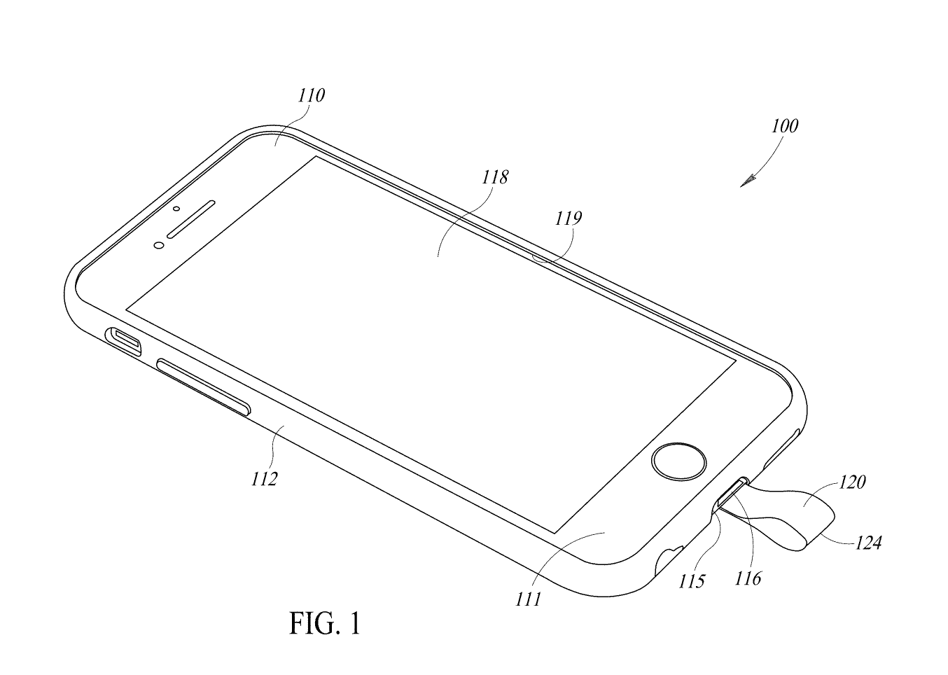

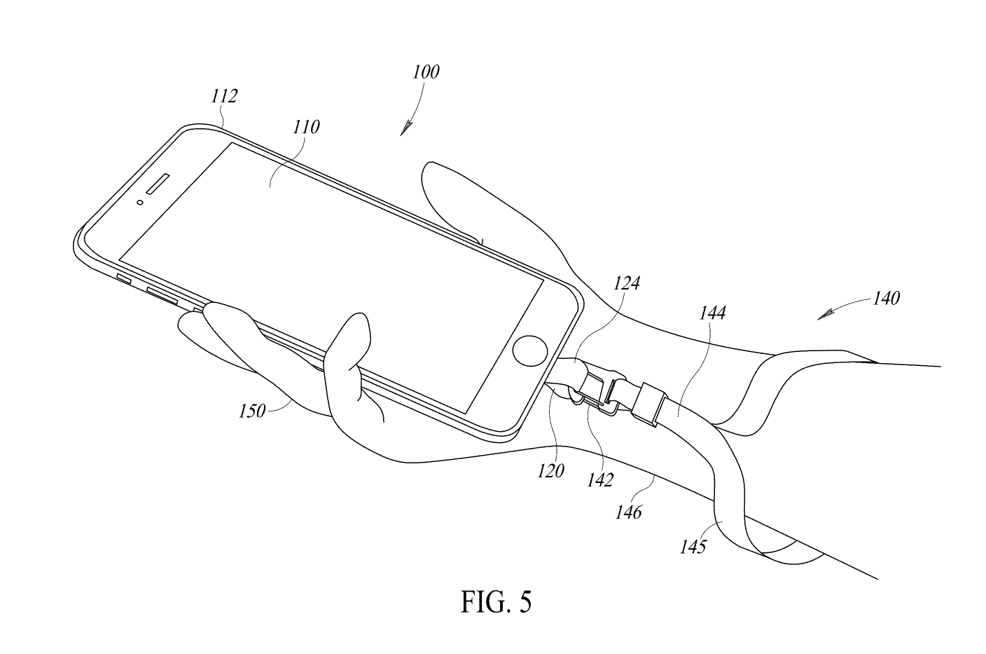

FIG. 1 illustrates an assembly 100 that includes a cellular telephone or cellphone 110 protected by a removable conventional cellphone case 112. As is apparent to those of ordinary skill in the art, the cellphone 110 includes an outer enclosure or case 111 that is separate from and positionable inside the case 112. The cellphone's case 111 protects internal components (not shown) of the cellphone 110. The cellphone 110 is fully operable without the case 112, which is typically added by a user 150 (see FIGS. 5-12). Generally, the case 112 is sold separately from the cellphone 110.

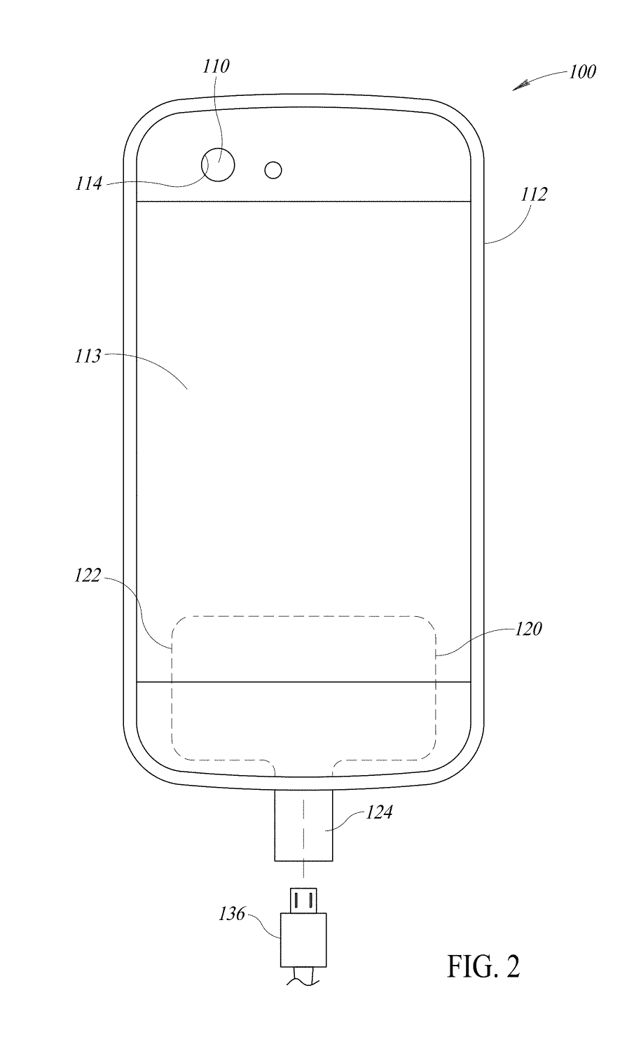

In the embodiment illustrated, the case 112 wraps around the sides of the cellphone 110 and grips the cellphone 110 (e.g., around its display 118). The case 112 may have a front aperture 119 through which the display 118 of the cellphone 110 may face outwardly to be viewed by the user 150 (see FIGS. 5-12). Referring to FIG. 2, the case 112 may include a generally solid back portion 113 with one or more optional openings 114 (e.g., through which a camera (not shown) of the cellphone 110 may capture images). As shown in FIG. 1, the case 112 includes a through-hole 115 aligned with a charging port 116 of the cellphone 110. Thus, the case 112 is configured to cover at least a portion of the cellphone 110 and, at the same time, not to interfere with the operation of the cellphone 110 by the user 150 (see FIGS. 5-12).

The case 112 may be configured to protect the cellphone 110 from damage (e.g., if the cellphone 110 is dropped by the user 150 illustrated in FIGS. 5-12). The case 112 may also be installed by the user 150 (see FIGS. 5-12) for aesthetic reasons. The case 112 is removable from the cellphone 110 and may be replaced, if the user 150 (see FIGS. 5-12) of the cellphone 110 so desires.

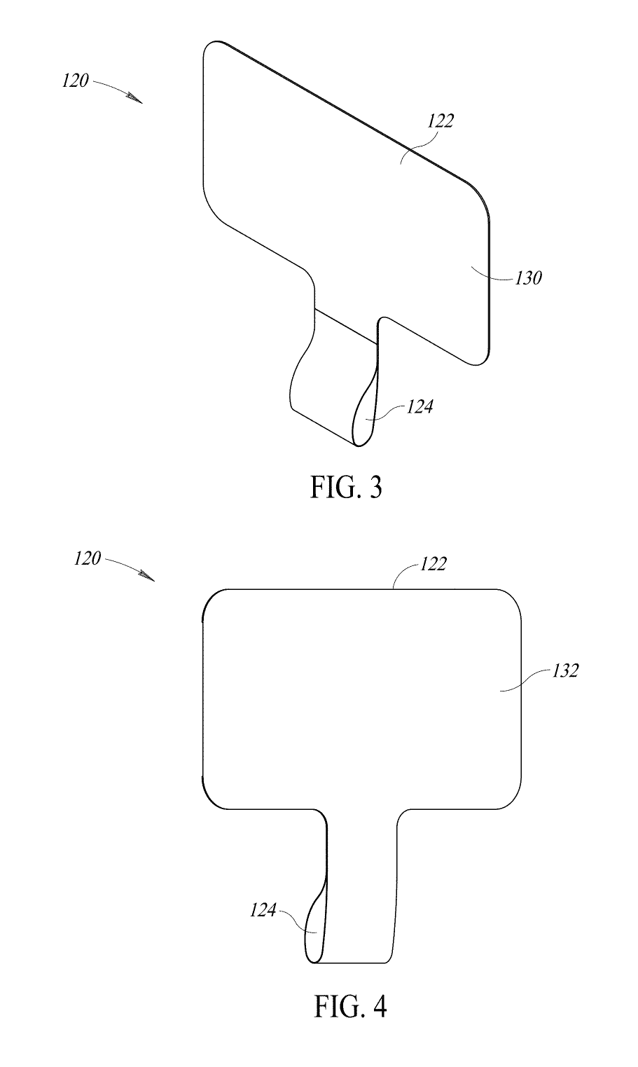

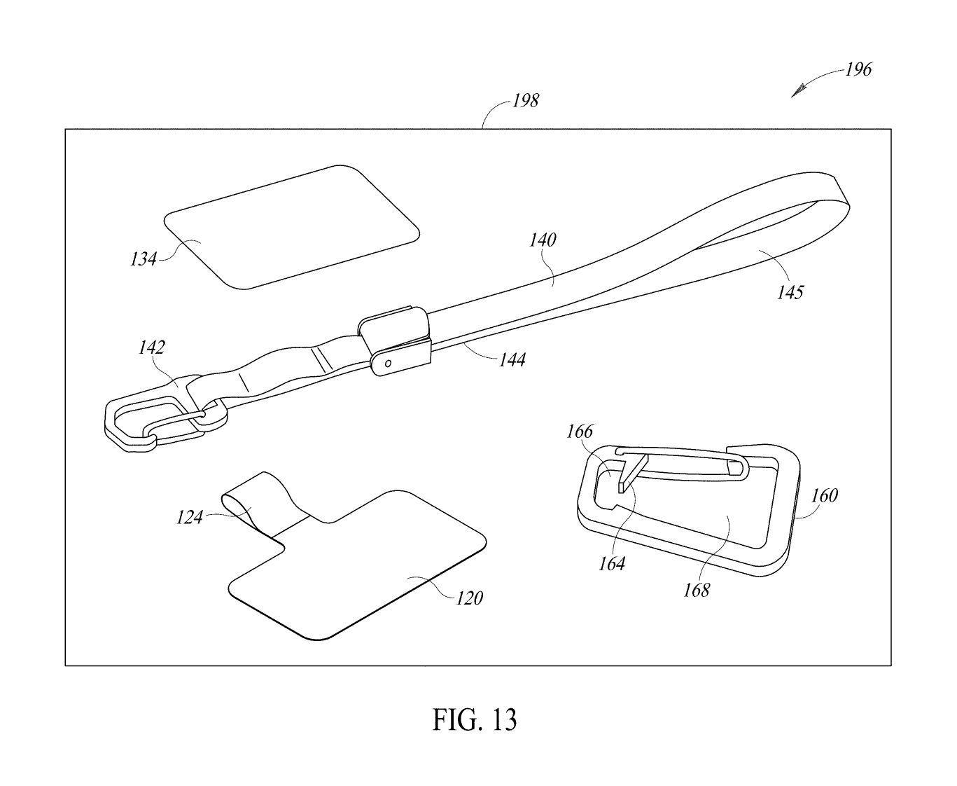

The assembly 100 also includes a carrier 120. Referring to FIG. 3, the carrier 120 has an anchor portion or tab 122 connected to a loop 124. The tab 122 has a cellphone facing first side 130 opposite a case facing second side 132 (see FIG. 4). Referring to FIG. 2, the tab 122 is configured to be positioned inside the case 112 behind the cellphone 110. Referring to FIG. 15, the first side 130 is positioned adjacent the cellphone 110 and the second side 132 (see FIG. 4) is positioned adjacent the case 112. Optionally, one or more pieces of double-sided tape (e.g., a piece of double-sided tape 134 illustrated in FIG. 13) may be used to help adhere the second side 132 (see FIG. 4) to the case 112 and/or to help adhere the first side 130 to the cellphone 110. By way of a non-limiting example, the piece of double-sided tape 134 (see FIG. 13) may be used to adhere the second side 132 (see FIG. 4) to the case 112. Alternatively, the piece of double-sided tape 134 (see FIG. 13) may be used to adhere the first side 130 to the cellphone 110. The piece of double-sided tape 134 may be particularly useful with cases in which the through-hole 115 is large enough to allow the tab 122 to pass therethrough.

Referring to FIG. 1, the loop 124 is configured to extend outwardly from inside the case 112 through the through-hole 115. When the loop 124 is positioned within the through-hole 115, the loop 124 does not obstruct or otherwise interfere with charging the cellphone 110. In other words, the user 150 (see FIGS. 5-12) may connect a charger 136 (see FIG. 2) to the charging port 116 when the loop 124 is positioned within the through-hole 115. Referring to FIG. 2, the charger 136 may be implemented as a charging plug configured to be received inside the charging port 116 (see FIGS. 1 and 15).

Referring to FIGS. 5, 6, 8, 10, and 12, the loop 124 may be coupled to other components and used to secure the assembly 100 to such other components. For example, referring to FIG. 5, the loop 124 may be attached to a wrist strap assembly 140 that includes a clasp 142 configured to hook onto the loop 124. The clasp 142 is coupled to a wrist strap 144 having a loop 145 configured to receive and be worn on a wrist 146 of the user 150. The user 150 may wear the wrist strap assembly 140, as shown in FIG. 5, with the assembly 100 attached thereto by the loop 124. Thus, the wrist strap assembly 140 makes it less likely that the user 150 will drop or misplace the assembly 100. The wrist strap assembly 140 also makes it more difficult to steal the cellphone 110.

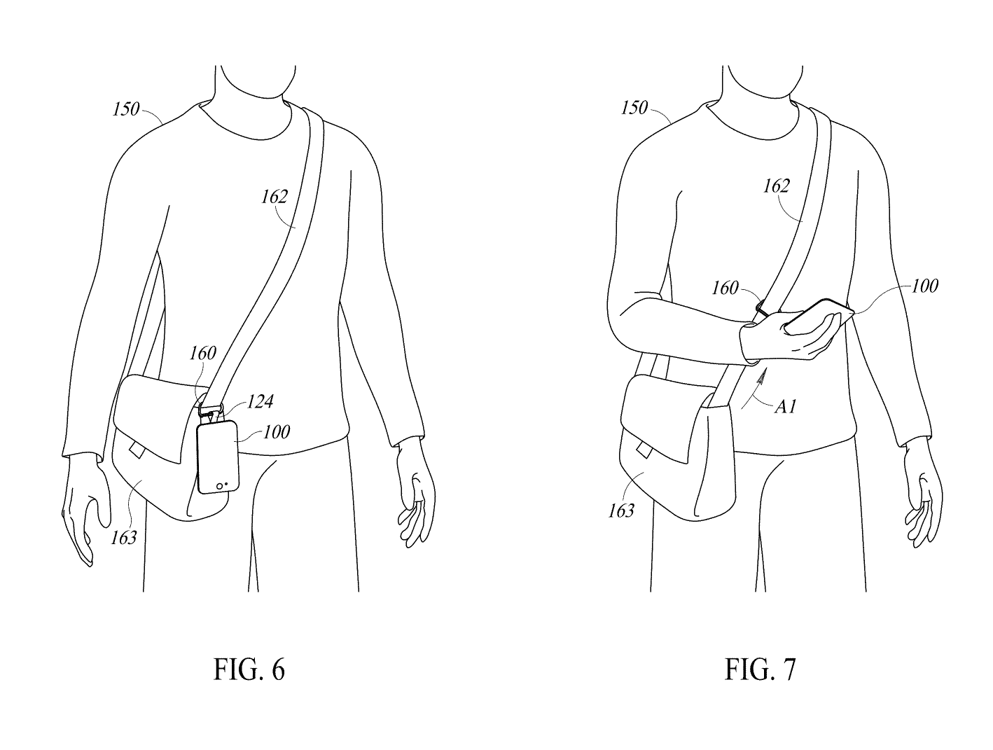

By way of another non-limiting example, in FIG. 6, the loop 124 is attached to a strap attachment 160 (e.g., a carabiner) that is attached to a strap 162 connected to a bag 163. The strap attachment 160 may have a generally tapered shape. As shown in FIG. 13, the strap attachment 160 may include a divider 164 positioned between a narrower portion 166 and a separate wider portion 168 of the strap attachment 160. The loop 124 may be positioned in the narrower portion 166 and the divider 164 may help maintain the loop 124 in the narrower portion 166. Referring to FIG. 6, the strap 162 is positioned inside the wider portion 168 (see FIG. 13) of the strap attachment 160. Referring to FIG. 7, when the user 150 wishes to use the cellphone 110 (see FIGS. 1, 2, 5, and 15), the user 150 may slide the strap attachment 160 along the strap 162 (e.g., in a direction identified by an arrow “A1”). When the user 150 is not using the cellphone 110 (see FIGS. 1, 2, 5, and 15), the assembly 100 may be positioned inside the bag 163. Thus, the assembly 100 may be stored in the bag 163 when not in use. Because the strap attachment 160 couples the assembly 100 to the strap 162, the user 150 is less likely to drop or misplace the cellphone 110 (see FIGS. 1, 2, 5, and 15). The strap attachment 160 also makes it more difficult to steal the cellphone 110 (see FIGS. 1, 2, 5, and 15). The strap attachment 160 may be constructed at least in part from polyoxymethylene (“POM”).

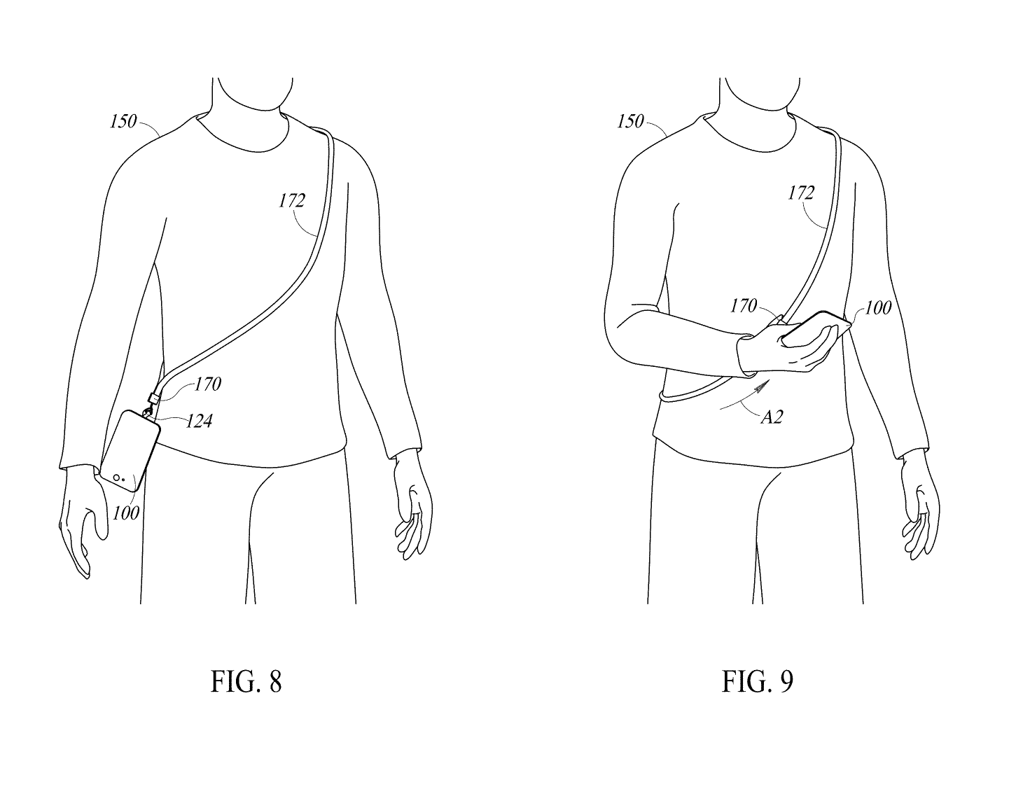

By way of another non-limiting example, in FIG. 8, the loop 124 may be attached to a clasp 170 of a cross-body sling strap 172. Referring to FIG. 9, when the user 150 wishes to use the cellphone 110 (see FIGS. 1, 2, 5, and 15), the user 150 may move (e.g., in a direction identified by an arrow “A2”) the cellphone 110 into a desired position. For example, the user 150 may slide the clasp 170 along the cross-body sling strap 172 or rotate the cross-body sling strap 172 about the user's body (e.g., if the clasp 170 is not configured to slide along the cross-body sling strap 172) to position the cellphone 110 in the desired position.

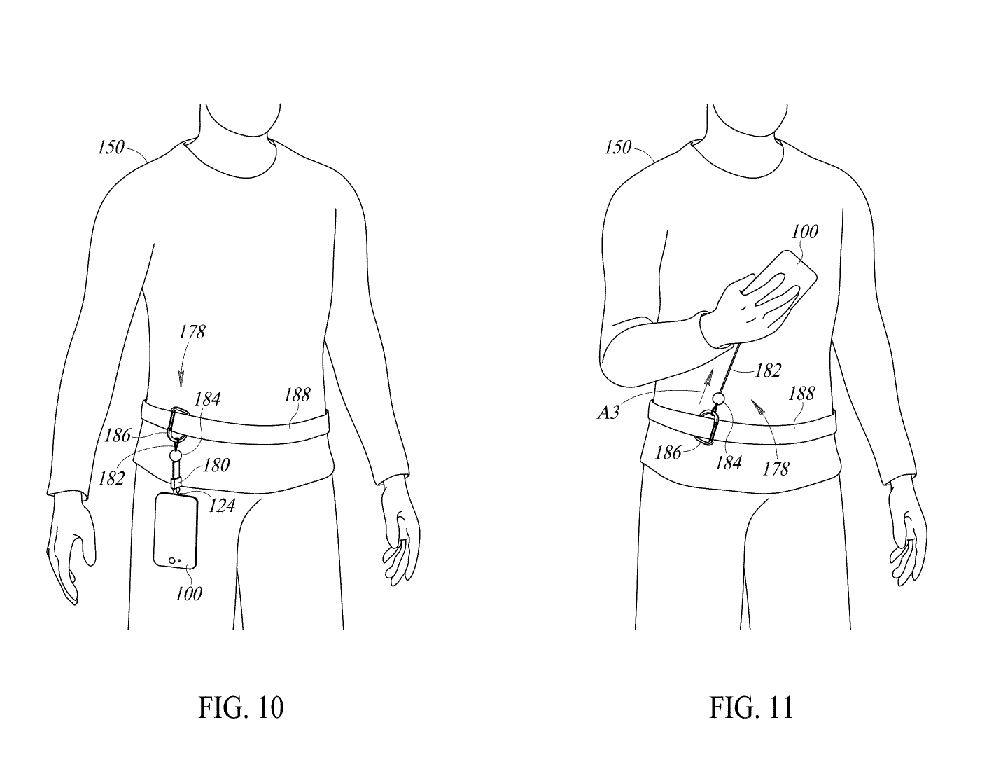

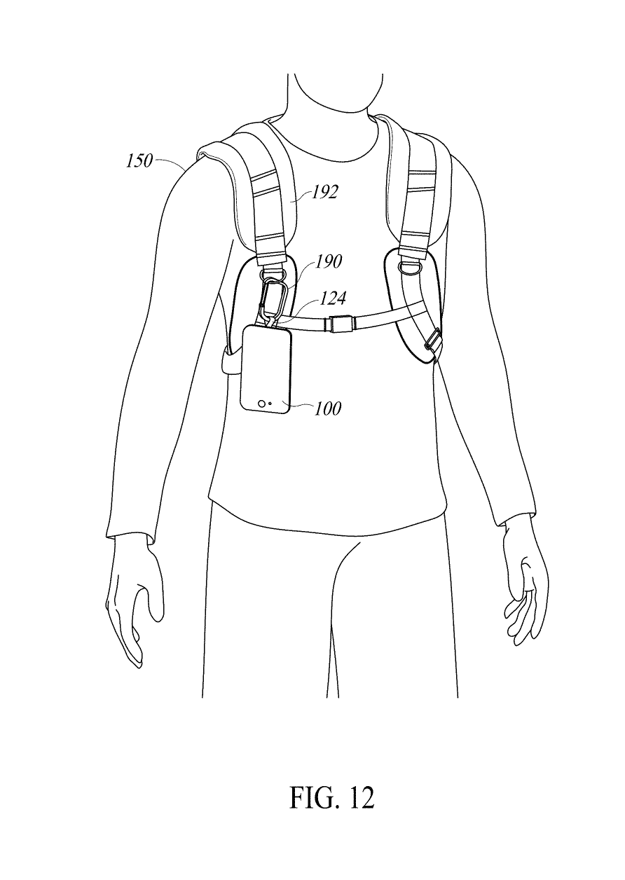

By way of another non-limiting example, in FIG. 10, the loop 124 may be attached to a retractable reel assembly 178. The loop 124 may be attached to a first clasp 180 attached to a cord 182 that is wound around a reel 184. The reel 184 may be attached to a second clasp 186 (e.g., a carabiner) that is attachable to the user 150 (e.g., to a belt 188 worn by the user 150). Referring to FIG. 11, when the user 150 wishes to use the cellphone 110 (see FIGS. 1, 2, 5, and 15), the user 150 may pull the assembly 100 way from the second clasp 186 (e.g., in a direction identified by an arrow “A3”), which unwinds the cord 182 from the reel 184 and allows the assembly 100 to be positioned where the user 150 desires. When the user 150 has finished using the cellphone 110, the user 150 may position the assembly 100 near the reel 184 to allow the reel 184 to retract the cord 182 automatically and thereby rewind the cord 182 onto the reel 184.

By way of another non-limiting example, in FIG. 12, the loop 124 is attached to a clasp 190 (e.g., a carabiner) that is hooked onto the user 150. In the embodiment illustrated, the clasp 190 couples the loop 124 to a backpack strap 192. Alternatively, the clasp 190 may be used to couple the loop 124 to the strap 162 (see FIGS. 6 and 7), the cross-body sling strap 172 (see FIGS. 8 and 9), the belt 188 (see FIGS. 10 and 11), a belt loop, a bag, a camera strap, a keychain, a tool belt, and the like.

FIG. 13 illustrates a kit 196 that includes the carrier 120. The kit 196 may also include one or more of the following: the wrist strap assembly 140, the strap attachment 160, the cross-body sling strap 172 (see FIGS. 8 and 9), the retractable reel assembly 178 (see FIGS. 10 and 11), and the clasp 190 (see FIG. 12). Optionally, the kit 196 may include the one or more pieces of double-sided tape (e.g., the piece of double-sided tape 134). The kit 196 may be packaged and sold in a box or package 198.

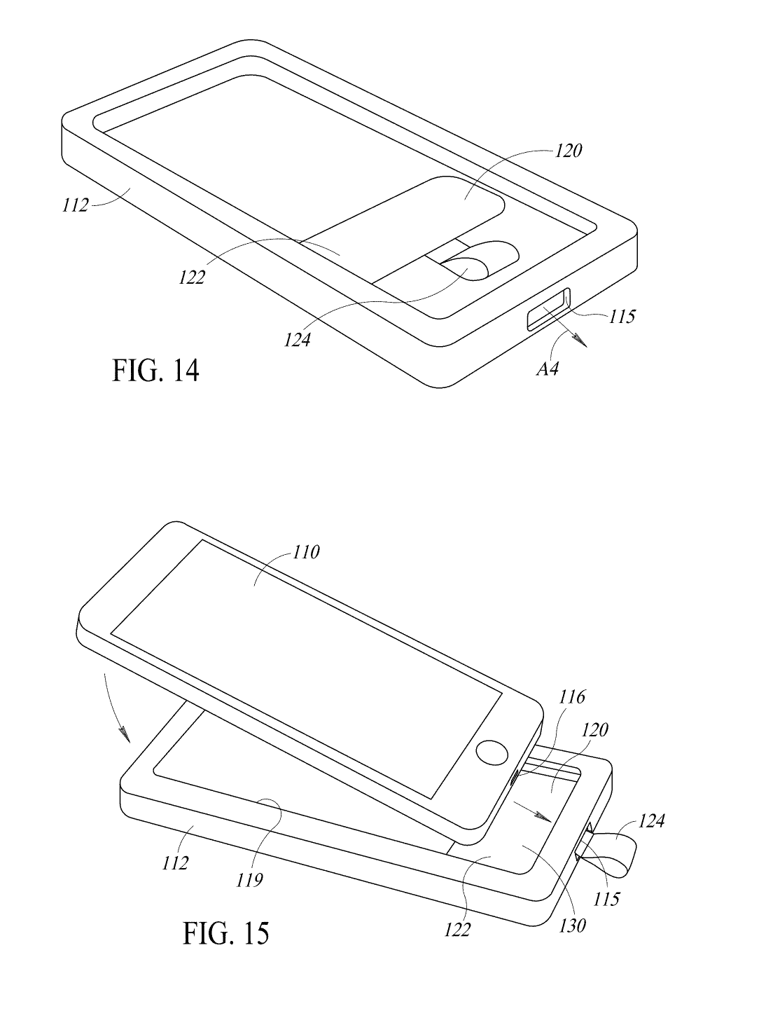

FIGS. 14 and 15 illustrate a method of constructing the assembly 100. Referring to FIG. 14, the carrier 120 is placed inside the case 112 with the second side 132 (see FIG. 4) facing the case 112. Then, the loop 124 is fed through the through-hole 115 (in a direction identified by an arrow “A4”). The loop 124 may pulled upon (in the direction identified by the arrow “A4”) until the tab 122 abuts a portion of the case 112 adjacent the through-hole 115. Then, referring to FIG. 15, the cellphone 110 is inserted into the case 112 through the front aperture 119 and traps the carrier 120 between the cellphone 110 and the case 112. The charging port 116 of the cellphone 110 is aligned with the through-hole 115 so that the cellphone 110 may be charged via the through-hole 115 when the cellphone 110 is positioned inside the case 112.

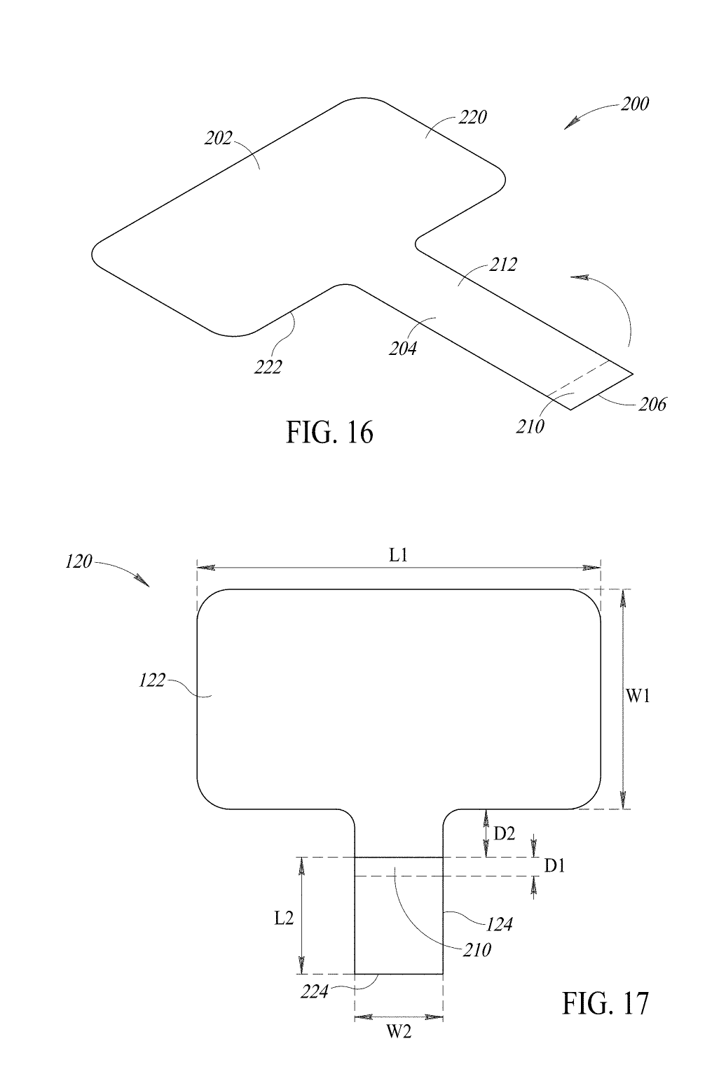

Referring to FIG. 16, the carrier 120 may be constructed from a single piece of generally T-shaped material 200 have a tab portion 202 connected to an outwardly extending loop portion 204. The loop portion 204 has a free end portion 206. The loop 124 (see FIGS. 1-6, 8, 10, 12-15, and 17) is formed by folding the loop portion 204 back on itself and attaching (e.g., sonically welding) an attached portion 210 of the free end portion 206 to an intermediate portion 212 of the loop portion 204. In the embodiment illustrated, the attached portion 210 is attached to the intermediate portion 212 along the cellphone facing first side 130 (see FIGS. 3 and 15) of the carrier 120 (see FIGS. 1-5, 13-15, and 17).

The material 200 has a first side 220 opposite a second side 222. By way of a non-limiting example, the material 200 may be coated on the first side 220 and/or the second side 222 with thermoplastic polyurethane (“TPU”). The material 200 may be cut into the T-like shape using any suitable process, including die cutting, laser cutting, and the like. The material 200 may have a finished thickness of about 0.65 millimeters (“mm”).

Referring to FIG. 17, by way of a non-limiting example, the tab 122 may have a length “L1” (e.g., about 55 mm) and a width “W1” (e.g., about 30 mm). The attached portion 210 may have a length “D1” (e.g., about 3 mm). The attached portion 210 may be spaced apart from the tab 122 by a distance “D2” (e.g., about 5 mm). The loop 124 may have a length “L2” (e.g., about 15 mm) from the attached portion 210 to a distalmost end 224 of the loop 124. The loop 124 may have a width “W2” (e.g., about 10 mm).

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A carrier for use with a cellular telephone and a removable case configured to receive the cellular telephone, the carrier comprising:
a tab portion configured to be positioned between the cellular telephone and the case when the cellular telephone is received within the case; and
a loop connected to the tab portion and extending outwardly therefrom, the loop being configured to extend outwardly from the case through a through-hole formed in the case when the tab portion is positioned between the cellular telephone and the case.

2. The carrier of claim 1, wherein the loop is configured to allow a charger to be inserted through the through-hole and into a charging port of the cellular telephone when the loop is extending outwardly through the through-hole.

3. The carrier of claim 1, wherein the tab portion has a telephone facing side opposite a case facing side, and the carrier further comprises:
a piece of double-sided tape configured to adhere the case facing side to the case.

4. The carrier of claim 1, wherein the tab portion has a telephone facing side opposite a case facing side, and the carrier further comprises:
a first piece of double-sided tape configured to adhere the case facing side to the case; and.
a second piece of double-sided tape configured to adhere the telephone facing side to the cellular telephone.

5. The carrier of claim 1, wherein the tab portion has a telephone facing side opposite a case facing side, and the carrier further comprises:
a piece of double-sided tape configured to adhere the telephone facing side to the cellular telephone.

6. The carrier of claim 1 constructed from a single piece of material having a first side opposite a second side.

7. The carrier of claim 6, wherein the single piece of material is coated with thermoplastic polyurethane on both the first and second sides.

8. A kit comprising:
a carrier comprising a tab connected to a loop, the tab being configured to be positioned between a cellular telephone and a cellular telephone case, the loop being configured to extend outwardly from the cellular telephone case through a through-hole formed in the cellular telephone case when the tab is positioned between the cellular telephone and the cellular telephone case; and
a wrist strap assembly comprising a clasp connected to a wrist strap, the clasp being configured to hook onto the loop, and the wrist strap having a wrist strap loop configured to receive a user's wrist.

9. The kit of claim 8, further comprising:
a strap attachment configured to hook onto both the loop and a strap to thereby attach the loop to the strap.

10. The kit of claim 9, wherein the strap attachment comprises a divider configured to help maintain the loop in a first portion of the strap attachment that is separate from a second portion of the strap attachment whereat the strap is positioned.

11. The kit of claim 9, further comprising:
at least one of a retractable reel assembly, a cross-body sling strap, and a clasp.

12. The kit of claim 8, further comprising:
at least one of a retractable reel assembly, a cross-body sling strap, and a clasp.

13. The kit of claim 8, further comprising:
a first piece of double-sided tape configured to adhere a case facing side of the tab to the cellular telephone case.

14. The kit of claim 13, further comprising:
a second piece of double-sided tape configured to adhere a telephone facing side of the tab to the cellular telephone, the telephone facing side being opposite the case facing side.

15. The kit of claim 8, further comprising:
a piece of double-sided tape configured to adhere a telephone facing side of the tab to the cellular telephone.

16. A kit comprising:
a carrier comprising a tab connected to a loop, the tab being configured to be positioned between a cellular telephone and a cellular telephone case, the loop being configured to extend outwardly from the cellular telephone case through a through-hole formed in the cellular telephone case when the tab is positioned between the cellular telephone and the cellular telephone case; and
a strap attachment configured to be hooked onto both the loop and a strap to thereby attach the loop to the strap.

17. The kit of claim 16, wherein the strap attachment comprises a divider configured to help maintain the loop in a first portion of the strap attachment that is separate from a second portion of the strap attachment whereat the strap is positioned.

18. The kit of claim 16, further comprising:
at least one of a retractable reel assembly, a cross-body sling strap, and a clasp.

19. The kit of claim 16, further comprising:
a first piece of double-sided tape configured to adhere a case facing side of the tab to the cellular telephone case.

20. The kit of claim 19, further comprising:
a second piece of double-sided tape configured to adhere a telephone facing side of the tab to the cellular telephone, the telephone facing side being opposite the case facing side.

21. The kit of claim 16, further comprising:
a piece of double-sided tape configured to adhere a telephone facing side of the tab to the cellular telephone.
